(19) United States
(12) Patent Application Publication
(10) Pub. No.: US 2012/0213457 A1
(43) Pub. Date: Aug. 23, 2012

(54) Linear Guide Unit

(75) Inventor: Jonathan R. Schroeder, Machesney Park, IL (US)

(73) Assignee: PACIFIC BEARING COMPANY, Rockford, IL (US)

(21) Appl. No.: 13/031,988

(22) Filed: Feb. 22, 2011

(51) Int. Cl. F16C 29/02

(52) U.S. Cl. 384/41

(57) ABSTRACT

A linear guide is provided including a carriage configured to ride on a rail for linear motion along an axis of travel. The rail includes a base rail and a pair of side rail portions each coupled to a respective side of the base rail by an attachment portion. The surface of the each of the attachment portions forms an obtuse angle with the surface of the base rail portion.

### FIELD OF THE INVENTION

This invention generally relates to linear motion mechanisms, and more particularly to linear motion mechanisms employing rails.

### BACKGROUND OF THE INVENTION

Linear guides are used in various applications, including print/scan, food processing, machine tool, and various other applications. In some applications, it is desirable that the linear guides be easily cleanable to prevent bacteria growth and contamination. In the past, linear guides including undercut grooves or channels were prone to chemical and contaminant build-up, were not easily cleaned, and, thus, easily became contaminated and were prone to bacteria growth. Additionally, past linear guides required many parts that were required to be in precise alignment to assure proper functionality of the linear guide.

For instance, some prior embodiments would utilize a plurality of separate guide blocks that were interconnected with one another by a carriage plate. Two guide blocks would be carried along a first side rail portion of the guide rail and two other guide blocks would be carried along a second parallel side rail portion of the guide rail. The four guide blocks would be interconnected by the carriage plate. Unfortunately, it was very difficult to obtain and maintain proper alignment of the four guide blocks to keep friction between the guide blocks and the side rails at a minimum level.

Thus, it would be desirable to provide a linear guide that is not prone to malfunction due to slight misalignment. It would further be desirable to provide a linear guide that is easily cleanable and not prone to contamination or bacterial growth. It would further be desirable to provide a linear guide system compatible with existing systems.

### BRIEF SUMMARY OF THE INVENTION

In one aspect, a linear guide unit is provided. The linear guide unit includes a guide rail. The guide rail includes a base rail having a top surface and a pair of side rail portions spaced apart from one another. The side rail portions define inner surfaces that generally face one another. The inner surfaces extend at obtuse angles relative to the top surface of the base rail. The linear guide unit also includes a carriage unit having at least one mounting channel configured to slidably engage with one of the side rails.

In one embodiment, no portion of the carriage is interposed between the pair of side rails when the carriage is mounted to the guide rail. In another embodiment, the carriage unit includes two mounting channels. In another embodiment, the carriage unit includes a top portion, a pair of side portions spaced apart from one another and each extending transversely from the top portion, and a pair of engagement flange portions each extending transversely from its respective side portion towards one another. Each engagement flange portion and side portion along with the top portion form one of the channels. In another embodiment, each engagement flange portion is configured to interface with the guide rail at a surface thereof. The surface may be generally linear.

In one embodiment, each of the side rails includes a top surface. The top surface faces away from the base rail. Each of the side rails also includes a bottom surface facing away from the top surface and generally parallel to the top surface. Each of the side rails also includes a outwardly facing side surface extending generally perpendicularly between the top and bottom surfaces. In one embodiment, the top portion of the carriage may define an upper boundary of each of the first channel and the second channel. In one embodiment, the at least one mounting channel includes first and second mounting channels. The carriage includes a top portion. The carriage also includes spaced apart first and second side arm portions extending away from the top portion. The carriage also includes first and second engagement flanges. The first engagement flange extends laterally inward from the first side arm portion. The second engagement flange extends laterally inward from the second side arm portion towards the first engagement flange. The first and second engagement flanges are spaced apart from the top portion. The first mounting channel may be formed between the top portion, the first engagement flange, and the first side portion. The second channel may be formed between the top portion, the second engagement flange, and the first side arm portion.

In one embodiment, the first and second mounting channels may have mouths formed between distal ends of the first and second engagement flanges and the top portion. In one embodiment, the top portion, the first side arm portion, and the first engagement flange may form a first generally C-shaped portion. The first generally C-shaped portion may generally bound the first mounting channel and provide three slide surfaces that slidingly interface with corresponding ones of the top, bottom, and outwardly facing surfaces of one of the side rails. The top portion second side arm portion and second engagement flange may form a second generally C-shaped portion, generally bounding the second mounting channel and providing three slide surfaces that slidingly interface with corresponding ones of the top, bottom, and outwardly facing surfaces of the other one of the side rails.

In another embodiment, the guide rail may be free of undercuts between the side rails and the base rail. In another embodiment, no portion of the carriage is interposed between the pair of side rails when the carriage is mounted to the guide rail.

In another aspect, the linear guide unit is provided. The linear guide unit includes a guide rail. The guide rail includes a pair of generally parallel side rail portions. Each side rail portion has a top surface, a bottom surface parallel to the top surface, and an outwardly facing surface extending generally perpendicularly between the top and bottom surfaces. The linear guide unit also includes a carriage. The carriage includes a top portion and defines a pair of generally parallel rail receiving channels. Each rail receiving channel may receive one of the side rail portions. The carriage may be configured to be slidably displaceable relative to the base rail along an access of travel.

In one embodiment, the guide rail may also include a base rail portion extending between the side rail portions. Each of the side rail portions may include an inwardly facing surface that generally faces the other one of side rail portions. Each of the inwardly facing surfaces may form an obtuse angle with the base rail portion. In one embodiment, the base rail portion may include a pair of outwardly facing surfaces. The outwardly facing surfaces may face generally away from one another. Each outwardly facing surface may form an obtuse angle with the bottom surface of the adjacent side rail portion.

In one embodiment, the carriage may further include a pair of side arm portions extending from the top portion. The carriage may also include a pair of inwardly facing flanges extending from the side arm portions generally parallel to the top portion. In one embodiment, the rail receiving channels may be generally C-shaped. The rail receiving channels may each be defined by the top portion, one of the side arm portions, and one of the flanges.

In one embodiment, no portion of the carriage is interposed between the pair of side rails when the carriage is mounted to the guide rail. The carriage may be slidably displaceable relative to the guide rail without contact with the base rail portion. In one embodiment, the first and second rail receiving channels have mouths formed between distal ends of the flanges and the top portion.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric view of an embodiment of a linear guide unit in accordance with the present invention including a carriage mounted on a rail;

FIG. 2 is an end view of a prior linear guide unit including polymer inserts;

FIG. 3 is an isometric view of the rail of FIG. 1;

FIG. 4 is an end view of the rail of FIG. 3;

FIG. 5 is an isometric top view of the carriage of FIG. 1;

FIG. 6 is an end view of the carriage of FIG. 5;

FIG. 7 is a partially exploded isometric bottom view of the carriage of FIG. 5 illustrating a brake;

FIG. 8 is a partially exploded isometric bottom view of the carriage of FIGS. 1 and 5-7; and

FIG. 9 is an end dimensioned view of the linear guide unit of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

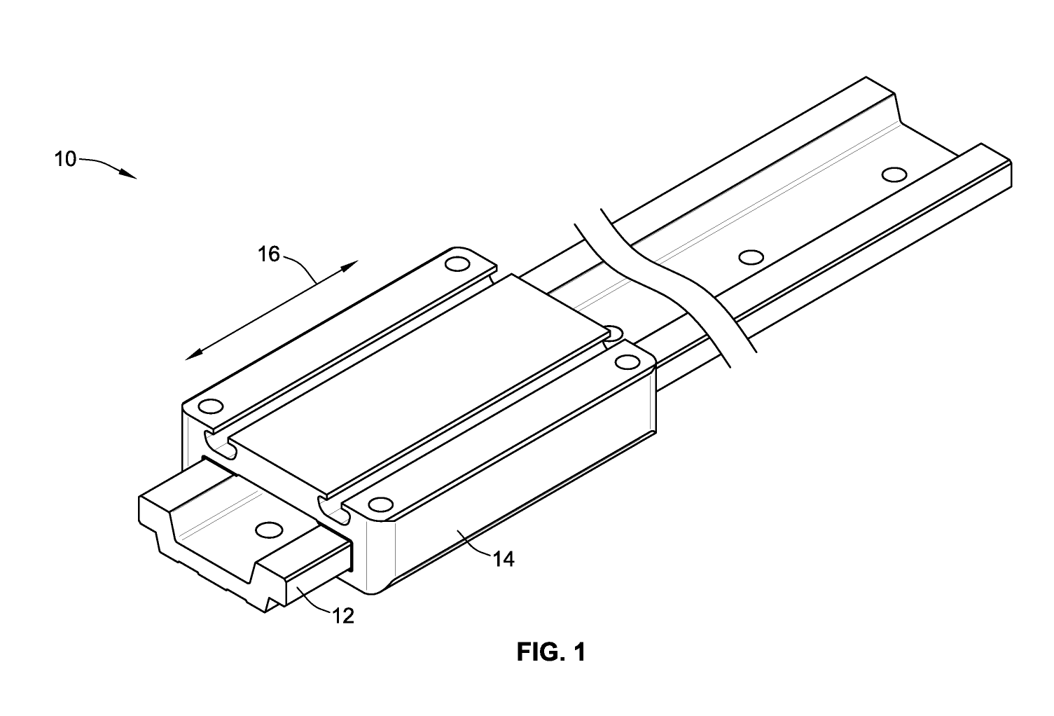

With regards to FIG. 1, an embodiment of a linear guide unit 10 is illustrated generally. The linear guide unit 10 includes a guide rail 12 and a carriage 14 engaged with the guide rail 12. The carriage 14 is generally slidably displaceable relative to the guide rail 12 along an axis of travel 16. The carriage 14 is mounted to the guide rail 12 such that there is substantially only a single degree of freedom therebetween.

The guide rail 12 may be formed from metal, such as aluminum, a combination of metals, or any other suitable material. The guide rail 12 may be of one piece construction, formed such as by extrusion, or extrusion and machining, substantially free from welds, bolts, etc. Additionally, other suitable methods of forming a guide rail 12 are also envisioned.

The carriage 14 may be formed of metal or any other suitable material, and may be of one piece construction, formed such as by extrusion, or extrusion and machining

Portions of the guide rail 12 and carriage 14 may be formed by methods such as those provided in PCT application WO 2010/078487, filed Dec. 31, 2009, and assigned to the assignee of the present application, incorporated herein, in its entirety, by reference. The guide rail 12 and the carriage 14 also may be formed by any suitable method.

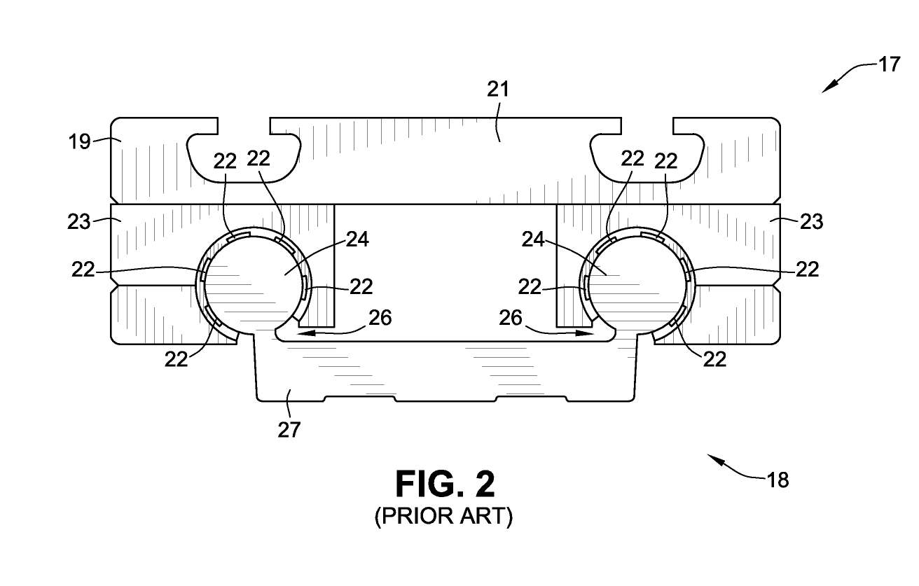

With reference to FIG. 2, a prior guide unit 17 is illustrated including a rail 18 and carriage 19. As can be seen from this end view, the carriage 19 is formed from a plurality of parts coupled together. More particularly, there is a carriage plate 21 coupled to two guide blocks 23. As noted previously, it can be difficult to perfectly align and maintain the alignment of these guide blocks 23, this is particularly true in embodiments where there additional guide blocks axially offset from the two illustrated guide blocks 23 along the axis of travel of the guide unit 17.

The carriage 19 includes polymer inserts 20 used to reduce friction between the guide rail 18 and the carriage 19. The polymer inserts 20 surround a portion of side rails 24.

Unfortunately, the side rails 24 along which the guide blocks 23 travel are generally cylindrical having a generally round outer surface. This circular cross-section has generated two problematic design features of this design.

Because the side rails 24 have the generally round cross-section, the polymer inserts 20 define grooves 22 to allow the inserts to cooperate with the circular outer surface of the side rails 24.

Additionally, because of this substantially circular cross-section, the side rails 24 form undercut regions 26 between the side rails 24 and base 27 of the rail 18.

Both the undercut regions 26 and the grooves 22 in the polymer inserts 20 add to the difficulty of cleaning the guide unit 17, and provide a place for contaminants to remain even after cleaning. Increased difficulty in cleaning and places for contaminants to reside despite cleaning, possibly leading to bacterial growth, may be undesirable.

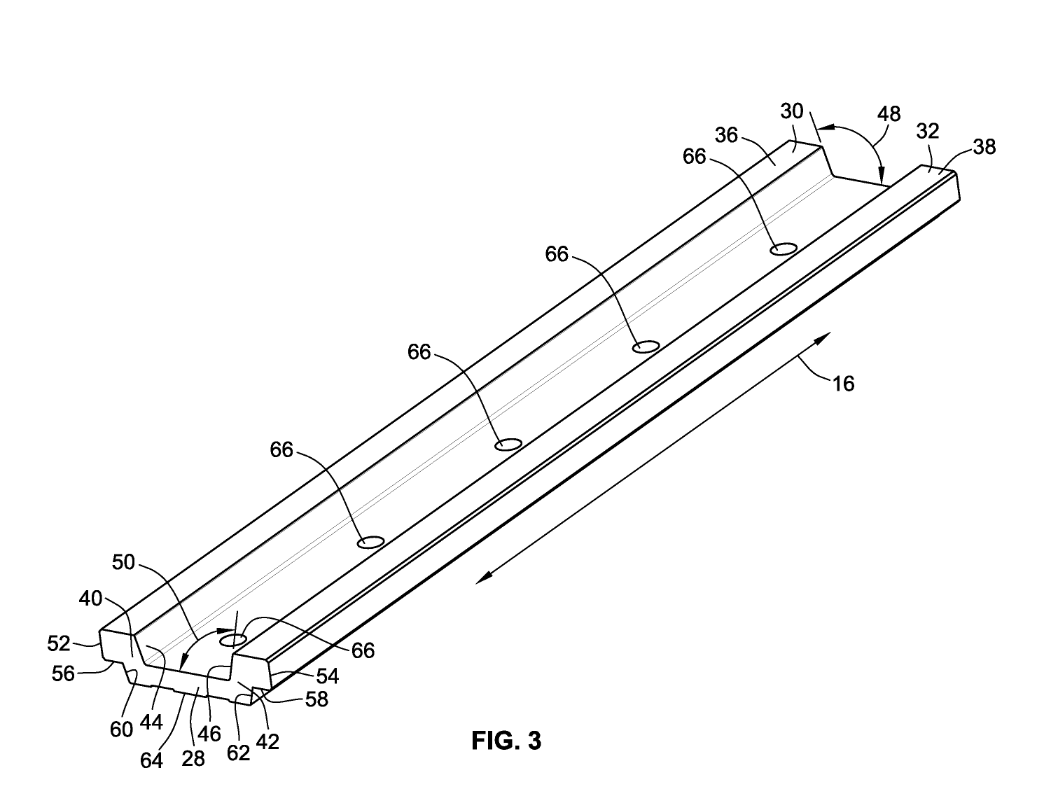

With reference to FIG. 3, the guide rail 12 is illustrated. The guide rail 12 extends longitudinally along the axis of travel 16 and includes a base rail portion 28 and a pair of side rail portions 30, 32 spaced apart from one another, extending longitudinally along respective sides of the base rail portion 28. The base rail portion 28 includes a generally flat top surface 34 extending laterally between the side rail portions 30, 32.

The side rail portions 30, 32 each define a generally flat top surface 36, 38 extending in a plane generally parallel to and above the top surface 34 of the base rail portion 28. The side rail portions 30, 32 are each coupled with the base rail portion 28 at an attachment portion 40, 42. Each side rail portion 30, 32 includes an inward facing surface 44, 46. The inward facing surfaces 44, 46 each define an obtuse angle 48, 50 with the top surface 34 of the base rail portion 28. As used herein, the angle shall be the shortest angular distance between the two surfaces defining the angle.

In one embodiment, the obtuse angles 48, 50 may be between 95 degrees and 120 degrees, more preferably between 100 and 115 degrees plus or minus five degrees. Other suitable angles are also envisioned.

With reference to FIG. 3, each side rail portion 30, 32 has an outer surface 52, 54 extending generally perpendicularly between a top surface 36, 38 and a bottom surface 56, 58 of the side rail portions 30, 32.

Bottom surfaces 56, 58 extend generally parallel to the top surfaces 36, 38 of the side rail portions 30, 32 between the outer surfaces 52, 54 and outward facing surfaces 60, 62 of the rail portion 28.

Each outward facing surface 60, 62 may extend parallel to each respective inward facing surface 44, 46 of the side rails 30, 32, however, other suitable configurations are also envisioned. The outward facing surface surfaces 60, 62 each extend between the bottom surfaces 56, 58 to opposite ends of a bottom surface 64 of the base rail portion 28. The bottom surface 64 of the base rail portion 28 extends generally parallel to the top surface 34 of the base rail portion 28.

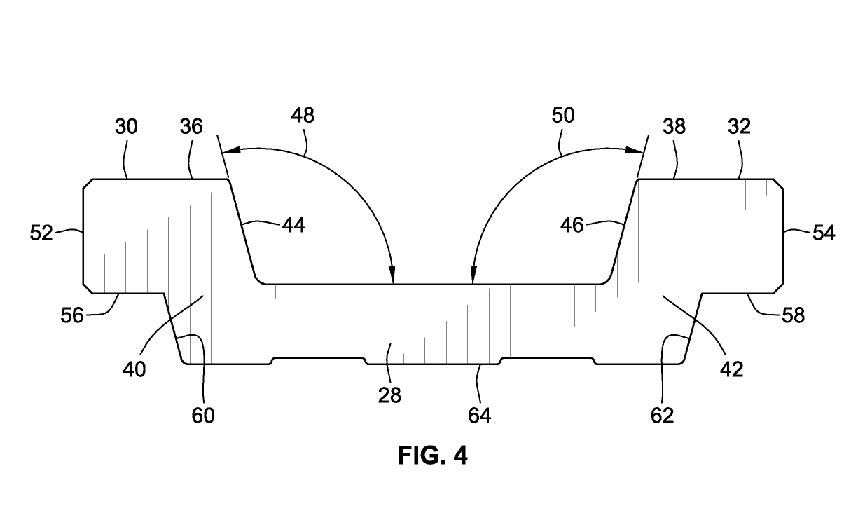

With further reference to FIGS. 3 and 4, the guide rail 12 may be configured to rest on the bottom surface 64 of the base rail portion 28 on a work surface relative to which linear movement may be desired. The base rail portion 28 defines a plurality of attachment apertures 66 formed therethrough and configured to receive a fastener (such as, e.g., a screw, bolt, tack, etc.) to couple the guide rail 12 to and hold the guide rail 12 in place relative to the work surface. While in one embodiment a fastener may be used, in other embodiments, other suitable means for fastening or fixing the position of the guide rail 12 to a work surface, including, for example, adhesive, or any other suitable means.

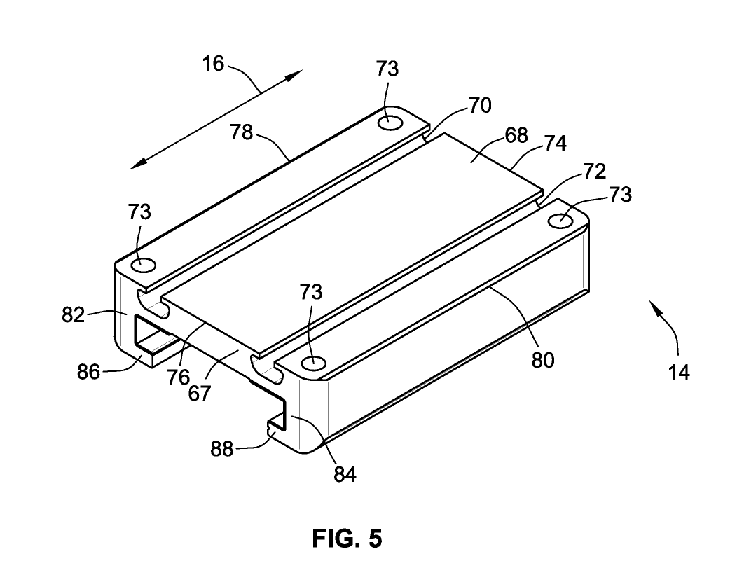

With reference to FIG. 5 a carriage 14 is described. The carriage 14 includes a top portion 67 having a top surface 68 that extends in the direction of the axis of travel 16. The carriage 14 may extend various suitable distances, based on various factors. In one embodiment the carriage 14 extends between approximately 100 millimeters and approximately 200 millimeters along the axis of travel 16.

As illustrated in FIG. 5, the top surface 68 of the carriage 14 defines a pair of T-slots 70, 72 separated by a distance transverse to the axis of travel 16. The T-slots 70, 72 may be standard T-slots configured to receive the head portion of a fastener to couple an apparatus to be linearly moved to the carriage 14, as would be immediately recognized by one having ordinary skill in the art.

Defined in the top surface 68 of the carriage 14 are multiple tapped holes 73 into which a fastener such as a screw may be inserted for fastening an apparatus to be linearly moved to the carriage 14. Additional other types of holes and slots, as well as other types of apparatus for fastening apparatus to be linearly moved to the carriage 14 are also envisioned.

In one embodiment, the top portion 67 is generally rectangular (the edges may be chamfered, beveled, etc.) and includes a pair of parallel sides 74, 76 transverse to the axis of travel 16 and a pair of parallel sides 78, 80 parallel with the axis of travel 16. Intersecting with each of the sides 78, 80 parallel with the axis of travel 16 is a side member 82, 84. The side members 82, 84 each extend transversely away from the top portion 67, each terminating at an engagement flange 86, 88. The engagement flanges 86, 88 extend inwardly towards one another, generally parallel to and spaced apart from the top surface 68.

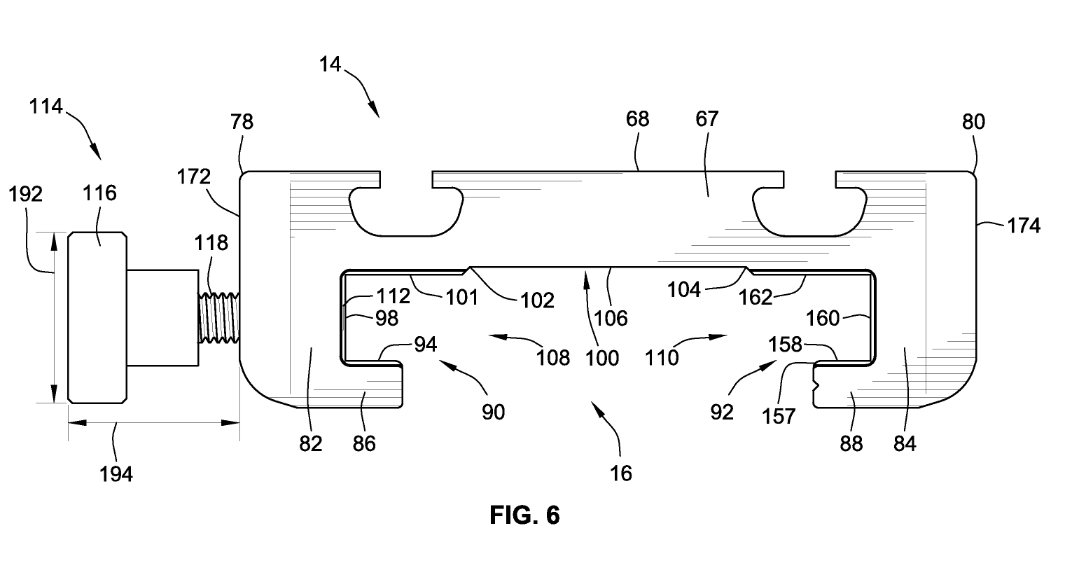

With reference to FIG. 6, the carriage 14 includes a pair of mounting channels 90, 92, which, as will be explained more fully below, are configured to receive and secure the guide rail 12, and particularly the side rail portions 30, 32. The mounting channels 90, 92 may be precision machined and may include a chemical compound adhered thereto for self-lubrication, such as, for example, the chemical sold by Pacific Bearing Co. under the trademark FRELON. The chemical compound may be applied to the entire mounting channels 90, 92 or to continuous or discontinuous portions thereof. The mounting channels 90, 92 form undercuts for securing the carriage 14 to the guide rail 12.

Machining of the engagement surfaces 90, 92 may be performed by methods disclosed in PCT application WO 2010/078487, or any other suitable method. The machining of the mounting channels 90, 92 provides for improved movement of the carriage relative to the guide rail 12.

Particularly with reference to FIG. 6, generally engagement flange 86, side member 82, and top portion 67 define a first C-shaped arm structure that defines mounting channel 90 configured to receive a side rail. Similarly, engagement flange 88, side member 84, and top portion 67 define a second C-shaped arm structure that defines mounting channel 92 configured to receive a side rail.

The top portion 67, arm structures, and engagement flanges 86, 88 may in one embodiment be a single piece of material made from singly extruding, singly machining, or singly extruding and machining a single piece of aluminum, other metal, or any other suitable material.

A first mounting channel 90 is described, with the other mounting channel 92 being a mirror image thereof, and described further below.

The first mounting channel 90 is defined by surfaces 94, 98 and 101. Top surface 94 of the engagement flange 86 (surface closest to the top portion 67) defines the first side of the mounting channel 90, which spans a selected distance along the top surface 94 of the engagement flange 86 in the direction of the axis of travel 16. The top surface 94 extends transversely to axis of travel 16 from the innermost edge 96 of the engagement flange 86 to an inner surface 98 of the side member 82. The inner surface 98 of the side member 82 extends generally transversely upwardly from top surface 94 of the engagement flange 86 to the underside 100 of the top portion 67. The inner surface 98 defines a second side of the first mounting channel 90. An engagement surface portion 101 of the underside 100 forms a third side of the mounting channel 90.

There is an unmachined surface portion 106 between the mounting channels 90, 92 on the underside 100 of the top portion 67. The mounting channels 90, 92 extend longitudinally in the direction of the axis of travel 16 over the entire length of the carriage 14 or various continuous or discontinuous portions thereof. As is illustrated in FIG. 6 and will be further described below, the mounting channels 90, 92 are open to one another and no portion of the carriage 14 extends transversely between the mounting channels 90, 92. The mounting channels 90, 92 face one another with mouths 108, 110 that allow the guide rail 12 to extend out of channels 90, 92. As such, when mounted to the guide rail 12, no portion of the carriage 14 is interposed between the side rail portions 30, 32. Thus, there is nothing inhibiting communication between the two mounting channels 90, 92. Additionally, when the carriage 14 is mounted on the rail 12 no part of the carriage 14 extends between or is interposed between the side rails 30, 32.

With further reference to FIG. 6, the second mounting channel 92 is further described. The second mounting channel 92 is defined by surfaces 158, 160, and 162. Top surface 158 of the engagement flange 88 (surface closest to the top portion 67) defines the first side of the second mounting channel 92, which spans a selected distance along the top surface 158 of the engagement flange 88 in the direction of the axis of travel 16. The top surface 158 extends transversely to axis of travel 16 from the innermost edge 157 of the engagement flange 88 to an inner surface 160 of the side member 84. The inner surface 160 of the side member 84 extends generally transversely upwardly from top surface 158 of the engagement flange 88 to the underside 100 of the top portion 67. The inner surface 160 defines a second side of the second mounting channel 92. An engagement surface portion 162 of the underside 100 forms a third side of the second mounting channel 92.

As may be seen, in one embodiment, no part of the carriage 14 will be slidingly engaged with either the top surface of the base rail 34 or the inward facing surfaces 44, 46. Thus, were contaminants or debris to accumulate in these areas, such contaminants or debris would not interfere with or affect the functionality of the linear guide unit 10.

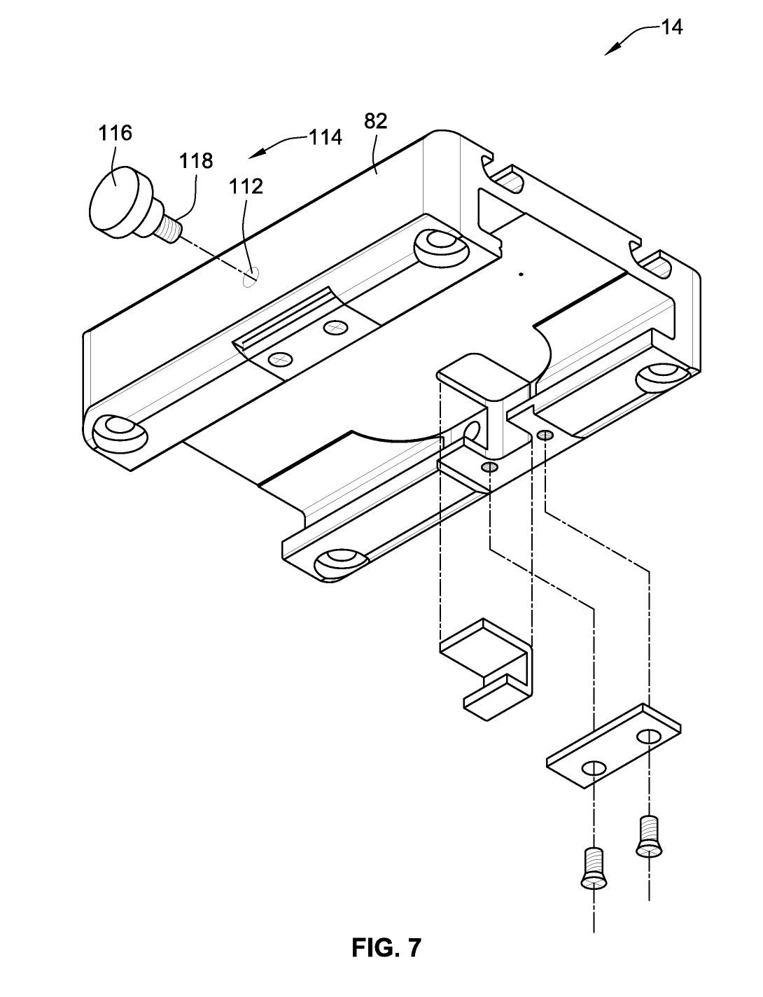

With reference to FIG. 7, the side member 82 defines a brake receiving aperture 112. A brake 114 is provided, including a gripping portion 116 and a cylindrical braking portion 118 coupled thereto and projecting therefrom. The braking portion 118 is configured to be received by the brake receiving aperture 112 and to pass through the side member 82. The gripping portion 116 is configured to be actuated by a user, the actuating of which causes the braking portion 118 to project into mounting channel 90.

When the carriage 14 is operatively mounted on a guide rail 12, actuating the gripping portion 116 will cause the breaking portion 118 to engage the side rail portion 30 and inhibit relative movement between the carriage 14 and the guide rail 12. The brake 114 may be actuated by pressing, turning (in one embodiment, the interior of the brake receiving aperture 112 and the exterior of the cylindrical braking portion 118 may be threaded), or any other suitable method.

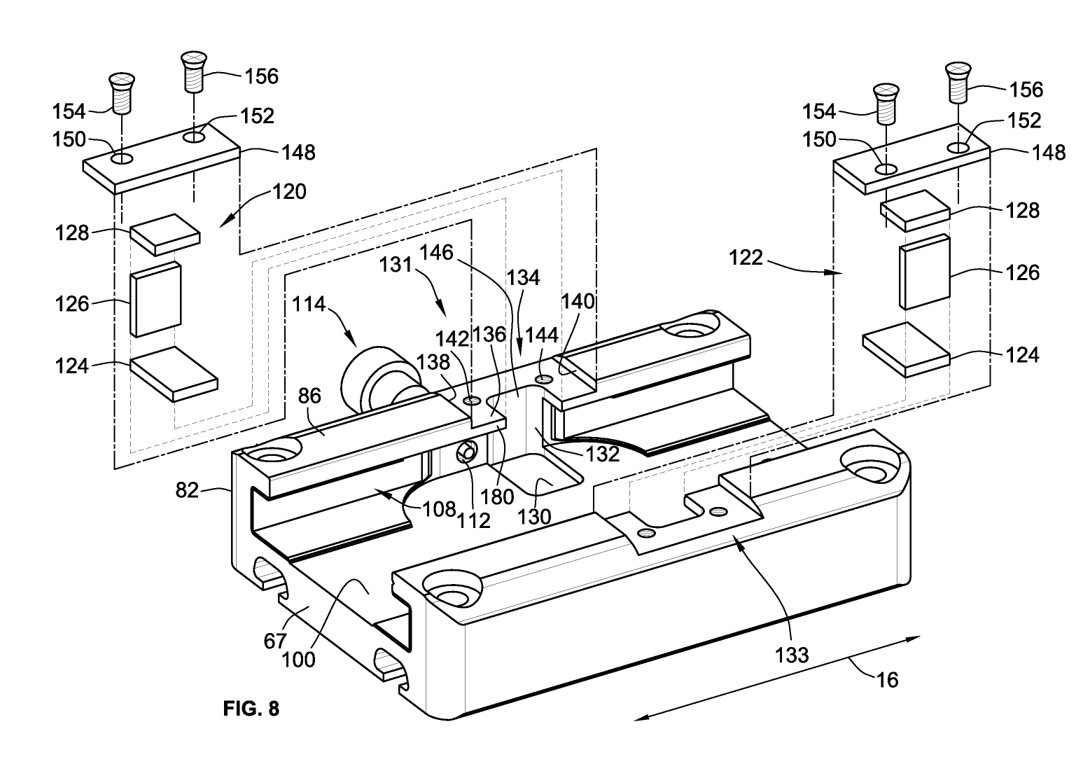

With reference to FIG. 8, in one embodiment a pair of lubricating felt wicks 120, 122 are provided. The wicks 120, 122 may be any type of suitable wick, and are configured to be coupled to the carriage 14 to provide reduced friction between the carriage 14 and the guide rail 12. The wicks 120, 122 include a first portion 124, a second portion 126, and a third portion 128. The wick portions 124, 126, 128 may be integrally formed with one another, or may be distinct pieces that may abut one another and may or may not be coupled to one another. The first portion 124 is preferably configured transverse to the second portion 126 and parallel with the third portion 128. In one embodiment, the portions 124, 126, 128 may be approximately 0.326 inch rectangular pieces, although other suitable sizes and shapes are envisioned.

With reference to FIG. 8, the carriage 14 may include a pair of wick receiving structures 131, 133. For clarity, the first wick receiving structure 131 is described, with the second wick receiving structure 133 being a mirror image thereof.

As illustrated in FIG. 8, defined into the underside 100 of the top portion 67 is a first wick receiving recess 130. The first wick receiving recess 130 may be of suitable size and depth to receive the first wick portion 124 therein, with the first wick portion 124 generally flush with the underside 100 of the top portion 67.

The first wick portion 124 may be secured within the first wick receiving recess 130 with an adhesive, for example a general purpose cyanoacrylate gap filling plastic bonder, such as that marketed by Henkel North America under the trademark LOCTITE 416. Other suitable means of securing the first wick portion 124 are also envisioned.

With further reference to FIG. 8, the first wick receiving recess 130 is contiguous with a second wick receiving recess 132 defined in the inner surface 98 of the side member 82, the second wick receiving recess 132 extending from the first wick receiving recess 130 towards the engagement flange 86. The second wick receiving recess 132 may be of suitable size and depth to receive the second wick portion 132 therein, with the second wick portion 126 generally flush with the inner surface 98 of the side member 82. The second wick portion 126 may also be secured within the second wick receiving recess 132 with an adhesive or any other suitable means.

As further illustrated in FIG. 8, the engagement flange 86 defines a plate receiving recess 134 defined by a base plate portion 136 extending along the axis of travel 16 between a first side wall 138 and a second side wall 140 spaced apart from the first side wall 138. Defined in the base plate portion 136 proximate the first side wall 138 is a first fastener receiving aperture 142. The base plate portion 136 further defines a second fastener receiving aperture 144 proximate the second side wall 140.

As illustrated in FIG. 8, the base plate portion 136 defines a cut-out portion 146 extending from between the fastener receiving apertures 142, 144 to the end surface of the flange 180. The cut-out portion 146 is configured to receive the third felt portion 128 therein, as will be described more fully below.

With reference to FIG. 8 an attachment plate 148 (illustrated in an exploded configuration) is provided defining a first attachment aperture 150 and a second attachment aperture 152. The attachment apertures 150, 152 are spaced apart and configured to receive a first fastener 154 and a second fastener 156 respectively. The attachment plate 148 may be generally rectangular and is sized to be received within the plate receiving recess 134 seated against the base plate portion 136. The third wick portion 128 may be coupled to the attachment plate 148 (by adhesive or any other suitable means) between the attachment apertures 150, 152, and located such that when the attachment plate 148 is seated within the plate receiving recess 134, the third wick portion 128 will be located within the cut out portion 146. The third wick portion 128 will be aligned flush with the top surface 94 of the engagement flange 86. The first attachment aperture 150 aligns with the first fastener receiving aperture 142 and the second attachment aperture 152 aligns with the second fastener receiving aperture 144. The attachment plate 148 is coupled to the carrier 14 by the first fastener 154 inserted through the first attachment aperture 150 and into the first fastener receiving aperture 142 and the second fastener 156 inserted through the second attachment aperture 152 and into the second fastener receiving aperture 144.

The fasteners 154, 156 may provide an interference fit with the fastener receiving apertures 142, 144. Alternatively, the fasteners 154, 156 may be threaded and the fastener receiving apertures 142 may be configured to interface with the threading to couple with the fasteners. Other suitable means of attachment are also contemplated.

When the carriage 14 is mounted on the guide rail 12, the side rail portion 30 is configured within the first mounting channel 90. The top surface 94 of the engagement flange 86 is in sliding communication with the bottom surface 56 of the side rail portion 30, the inner surface 98 of the side member 82 is in sliding communication with the outer surface 52 of the side rail portion 30, and the engagement portion 101 of the underside 100 of the top portion 67 is in sliding communication with the top surface 36 of the side rail 30.

Similarly, the side rail portion 32 is configured within the second mounting channel 92. The top surface 158 of the engagement flange 88 is in sliding communication with bottom surface 62 of the side rail portion 32, the inner surface 160 of the side member 84 is in sliding communication with the outer portion 54 of the side rail portion 32, and the engagement surface portion 162 of the underside 100 of the top portion 67 is in sliding communication with the top surface 38 of the side rail portion 32.

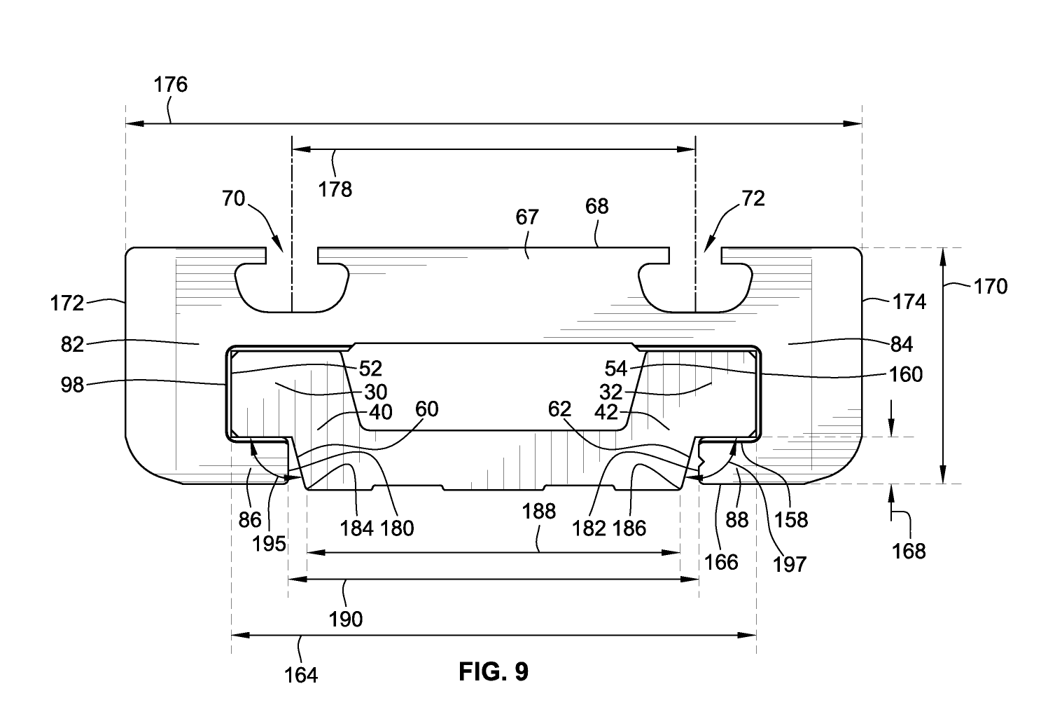

Thus, as may be seen, for example, in FIG. 9, in the illustrated embodiment, in contrast with the prior linear guide 17, the channels 90, 92 may be essentially three-sided, and thus, can securely and properly locate the carriage 14 relative to the rail 12 without wrapping completely around the side rail portions 30, 32.

With reference to FIG. 9, the carriage 14 may be formed to precise specifications, such that it is precisely mounted to and guided by the guide rail 12. In this embodiment, the outer portion 52 of the side rail portion 30 is separated from the outer portion 54 of the side rail 32 by a distance 164 of between approximately forty and sixty millimeters, more preferably approximately fifty-two millimeters. Similarly, the inner surface 98 of the side member 82 of the carriage 14 is separated from the inner surface 160 of the side member 84 by substantially the same distance 164.

The engagement flange 88 extends vertically from its top surface 158 to its bottom surface 166 a distance 168. In one embodiment the distance 168 is between approximately four and eight millimeters, more preferably approximately five and nine-tenths millimeters. The carriage 14 extends vertically from the bottom surface 166 of the engagement flange 88 of the engagement flange 88 to the top surface 68 of the top portion 67 a vertical distance 170. In one embodiment, the distance 170 may be between approximately twenty and thirty millimeters, more preferably approximately twenty-four millimeters.

Each of the side members 82, 84 includes an outer surface 172, 174 extending generally transverse to the top surface 68 and generally parallel with one another and with the axis of travel 16. The outer surfaces 172, 174 are separated by a distance 176. In one embodiment the distance 176 may be between approximately sixty-five and eighty-five millimeters, and more preferably approximately seventy-three millimeters.

The T-slots 70, 72 defined in the top surface 68 of the top portion 67 are defined a distance 178 apart from one another, the distance 178 being measured between the centers of the T-slots 70, 72. In one embodiment, the distance 178 may be between approximately thirty and fifty millimeters, more preferably approximately forty millimeters.

The bottom surface 64 of the base rail portion 28 extends transversely to the axis of travel 16 between the outward facing surfaces 60, 62 transitioning at two transition points 184, 186. The transition points 184, 186 are separated by a distance 188. In one embodiment, the distance 188 may be between approximately thirty and forty-five millimeters, and more preferably approximately thirty-seven and one-tenth millimeters. The engagement flanges 86, 88 extend towards one another, respectively terminating at flange end surfaces 180, 182. The flange end surfaces 180, 182 are separated by a distance 190. The distance 190 may be between approximately thirty and fifty millimeters, and more preferably approximately forty millimeters. Because the outward facing surfaces 60, 62 extend outwardly transverse to the axis of travel 16 beyond the transition points 184, 186, the distance 190 may in one embodiment be sufficiently greater than the distance 188 to allow movement of the carriage 14 relative to the guide rail 12 without contact between the flange end surfaces 180, 182 and the outward facing surfaces 60, 62.

With further reference to FIG. 6, the gripping portion 116 of the brake 114 in one embodiment may be cylindrical and may have a diameter 192. In one embodiment the diameter 192 may be between approximately fifteen and twenty-five millimeters, and more preferably approximately nineteen and three-tenths millimeters. Additionally, the brake may project from the outer surface 172 of the side member 82 substantially transversely to the axis of travel 16 a distance 194. In one embodiment, the distance 194 may be between approximately fifteen and twenty-five millimeters, and more preferably approximately nineteen and a half millimeters.

As illustrated in FIG. 9, the outward facing surfaces 60, 62 form angles 195, 197 with the bottom surface 56, 58 of the side rails 30, 32. These angles 195, 197 may be substantially identical, may be obtuse, and may be the same as or different than angles 48, 50. The angles 195, 197 may be between approximately 95 and 120 degrees, and, more preferably, between approximately 100 and 115 degrees.

Each outward facing surface 60, 62 may extend parallel to each respective inward facing surface 44, 46, however, other suitable configurations are also envisioned. The outward facing surfaces 60, 62 will each extend between the bottom surfaces 56, 58 of the respective side rails 30, 32 to opposite ends of the bottom surface 64 of the base rail portion 28. The bottom surface 64 of the base rail portion 28 may extends generally parallel to the top surface 34 of the base rail portion 28 and may include various other features suitable for interfacing with a work surface.

With regard to all of the dimensions discussed above, these dimensions are exemplary. Other suitable dimensions are also envisioned.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A linear guide unit comprising:
a guide rail defining a travel axis, including a base rail having a top surface, a pair of side rail portions spaced apart from one another in a direction generally perpendicular to the travel axis, each of the side rail portions defining inner surfaces that generally face one another;
wherein the inner surfaces extend at obtuse angles relative to the top surface of the base rail; and
a carriage unit having at least one mounting channel configured to slidably engage with one of the side rails.

2. The linear guide unit of claim 1, wherein no portion of the carriage is interposed between the pair of side rails when the carriage is mounted to the guide rail.

3. The linear guide unit of claim 1, wherein the carriage unit includes two mounting channels.

4. The linear guide unit of claim 3, wherein the carriage unit includes a top portion, a pair of side portions spaced apart from one other and each extending transversely from the top portion, and a pair of engagement flange portions each extending transversely from its respective side portion towards one another, each engagement flange portion and side portion along with the top portion forming one of the channels.

5. The linear guide unit of claim 4, wherein each engagement flange portion is configured to interface with the guide rail at a surface thereof and wherein the surface is generally linear.

6. The linear guide unit of claim 1, wherein each of the side rails includes a top surface facing away from the base rail, a bottom surface facing away from the top surface and generally parallel to the top surface, an outwardly facing side surface extending generally perpendicularly between the top and bottom surfaces.

7. The linear guide of claim 4, wherein the top portion of the carriage defines an upper boundary of each of the first channel and the second channel.

8. The linear guide of claim 6, wherein the at least one mounting channel including first and second mounting channels, the carriage including a top portion, spaced apart first and second side arm portions extending away from the top portion, and first and second engagement flanges, the first engagement flange extending laterally inward from the first side arm portion and the second engagement flange extending laterally inward from the second side arm portion toward the first engagement flange; the first and second engagement flanges being spaced apart from the top portion, the first mounting channel being formed between the top portion, the first engagement flange, and the first side arm portion, the second mounting channel being formed between the top portion, the second engagement flange, and the first side arm portion.

9. The linear guide of claim 8, wherein the first and second mounting channels have mouths formed between distal ends of the first and second engagement flanges and the top portion.

10. The linear guide of claim 9, wherein the top portion, the first side arm portion and the first engagement flange form a first generally C-shaped portion generally bounding the first mounting channel and providing three slide surfaces that slidingly interface with corresponding ones of the top, bottom, and outwardly facing surfaces of one of the side rails and wherein the top portion, the second side arm portion, and the second engagement flange form a second generally C-shaped portion generally bounding the second mounting channel and providing three slide surfaces that slidingly interface with corresponding ones of the top, bottom, and outwardly facing surfaces of the other one of the side rails.

11. The linear guide of claim 10, wherein the guide rail is free of undercuts between the side rails and the base rail.

12. The linear guide of claim 10, wherein no portion of the carriage is interposed between the pair of side rails when the carriage is mounted to the guide rail.

13. A linear guide unit comprising:
a guide rail including a pair of generally parallel side rail portions each having a top surface, a bottom surface parallel to the top surface, and an outwardly facing surface extending generally perpendicularly between the top and bottom surfaces, the outwardly facing surface facing away from one another and being generally parallel to one another and
a carriage including a top portion and defining a pair of generally parallel rail receiving channels each for receiving one of the side rail portions;
wherein the carriage is configured to be slidably displaceable relative to the guide rail along an axis of travel.

14. The linear guide unit of claim 13, wherein the guide rail further includes a base rail portion extending between the side rail portions; and
wherein each of the side rail portions includes an inwardly facing surface that generally faces the other one of the side rail portions, each of the inwardly facing surfaces forming an obtuse angle with the base rail portion.

15. The linear guide unit of claim 14, wherein the base rail portion includes a pair of outwardly facing surfaces, the outwardly facing surfaces facing generally away from one another, each outwardly facing surface forming an obtuse angle with the bottom surface of the adjacent side rail portion.

16. The linear guide unit of claim 13, wherein the carriage further includes a pair of side arm portions extending from the top portion and a pair of inwardly facing flanges extending from the side arm portions generally parallel to the top portion.

17. The linear guide unit of claim 16, wherein the rail receiving channels are generally C-shaped and are each defined by the top portion, one of the side arm portions, and one of the flanges.

18. The linear guide of claim 13, wherein no portion of the carriage is interposed between the pair of side rails when the carriage is mounted to the guide rail.

19. The linear guide of claim 14, wherein the carriage is slidably displaceable relative to the guide rail without contact with the base rail portion.

20. The linear guide of claim 8, wherein the first and second rail receiving channels have mouths formed between distal ends of the flanges and the top portion.
